(19) United States
(12) Patent Application Publication
(10) Pub. No.: US 2008/0195459 A1
(43) Pub. Date: Aug. 14, 2008

(54) METHOD FOR EVALUATING MEDIA PRODUCTS FOR PURPOSES OF THIRD-PARTY ASSOCIATION

(76) Inventor: BRENT STINSKI, New York, NY (US)

Correspondence Address: MCKEE, VOORHEES & SEASE, P.L.C., 801 GRAND AVENUE, SUITE 3200, DES MOINES, IA, 50309-2721, US

(21) Appl. No.: 11/672,803

(22) Filed: Feb. 8, 2007

(51) Int. Cl. G07G 1/00

(52) U.S. Cl. 705/10

(57) ABSTRACT

A method of evaluating media products through use of collective intelligence, for purposes of third-party association with a media product, such as advertising, product placement, licensing, and more, includes making a representation of each of the candidate media products available to a plurality of evaluators and providing an electronic forum for the plurality of evaluators to engage in a process in which the evaluators evaluate and predict performance of the candidate media products until a deadline is reached and wherein a sponsor of the forum rewards evaluators with a payoff for correct predictions of the performance of said candidate media products within the electronic forum and penalizes evaluators for incorrect predictions of the performance of said candidate media products within the forum after the deadline is reached.

### CROSS-REFERENCE TO RELATED APPLICATIONS

Although priority is not claimed, METHOD FOR SELECTING MEDIA PRODUCTS, Ser. No. 11/565,096, filed Nov. 30, 2006, and METHOD FOR SELECTING MEDIA PRODUCTS NOT WIDELY KNOWN TO THE PUBLIC AT LARGE FOR INVESTMENT AND DEVELOPMENT, Ser. No. 11/291,559 filed Dec. 1, 2005, are both hereby incorporated by reference in their entirety.

### BACKGROUND OF THE INVENTION

The invention relates generally to the early evaluation of media products not widely known to the public at large for purposes of aiding third-party entities in decisions of whether to pursue association with said media products by way of advertising, licensing, joint-ventures, sponsorship, or other forms of association.

Almost always, third-party entities in the media industry have an interest in identifying, ideally as early as possible, how well a given media product might perform. In media, of course, the bulk of the work in producing media products falls to creators or producers (musicians, writers, directors, producers and more); then, support entities (media conglomerates, television networks, record companies) almost always aid in distributing and marketing those media products. But almost always crucial third parties are also involved, in the form of advertisers, corporate sponsors, co-investors, or companies wishing to do product placement, licensing deals, or joint-marketing ventures related to the media products in question. This triumphirate of participants in the media production process all share one common goal: they all want a given media product they are sponsoring to perform well, by way of high sales (of tickets, CDs, or book copies, for example), high television ratings, or simply garnering a high degree of public attention. A prior application by this author (application Ser. No. 11/291,559), discusses a superior method for media companies to select high-value candidate media products for purposes of investment and development. This application discusses how a similar method can be used to help third-party entities to identify at a very early stage media products that are likely to perform well, and thereby maximize any third-party investment in, or association with, the media product in question.

Advertisers, as a rule, face two simple tasks. First, they wish to associate themselves with successful media products—that is, products that attract high levels of ratings, public attention, or sales. Second, they wish to undertake this association as early as possible in the product's development cycle—if only for the simple reason that the cost of advertising or other third-party association is low when a media product is still in development or not yet known to the public at large, and comparatively higher once the product has been released or has begun attracting significant attention. In general, then, third-parties must predict the performance of new media products unknown to the public, and they must do this as accurately and as early as possible. And the benefits are clear: an advertiser maximizes investment by advertising on a hit show as opposed to a flop; a company wishing to do a joint-marketing ventures for recorded music—for example, a café that wishes to sell copies of a newly released CD—maximizes investment by associating themselves with music that people will want to hear.

But prediction is difficult indeed. For one, in media there is a natural surplus of products, not all of which can perform well. In any given weekend, for example, a number of movies are released to the general public, each competing for a limited pool of ticket sales revenue. On any given evening, a vast number of television shows are available via terrestrial, cable, and satellite channels—each competing for a limited pool of audience attention. Elsewhere, vast numbers of books and CDs compete for shelf space, public attention, and sales. In such a situation, clearly, it is inevitable that some media products will outperform others. Clearly third-parties face a steep challenge: the right prediction enables maximal effectiveness of their investment, the wrong prediction leads to ineffective investment and significant opportunity cost. Sheer competition alone puts third parties in a difficult position.

But this is only the beginning. Third-parties seeking association with media products have virtually no reliable method for making these all-important predictions—if only because, it seems, no one does. Historically almost everyone associated with the media industry—media producers and artists, media companies, third-parties such as advertisers, and even journalists and other external observers—has struggled greatly to fashion accurate forecasts, no less at an early stage of media product development. Every year, media industries produce a number of failures, releasing films, books, television series, and musical recordings that are not embraced by the public. In music, historically, as many as 19 of 20 CDs do not recoup their initial investment. In film, we often witness stunning flops, such as Heaven's Gate and Ishtar, which lost their creators more than $40 million each. To top it off'amid these notable failure rates and flops—we also see stunning missed opportunities, as media companies pass on media content that, once given an opportunity, earns unexpectedly high returns. More than one record label passed on bands like Nirvana and R.E.M., and more than one movie studio refused to release record-setting films like The Passion of the Christ or Fahrenheit 9/11. Such variability in media led screenwriter William Goldman to make his famous proclamation about Hollywood, one that applies to the media industry as a whole: “Nobody knows anything.”

These two factors—extreme competition, combined with the extreme difficulty of forecasting—raise profound challenges for third-party entities interested in associating themselves with media products, ideally at an early stage of their development. In such a situation, media companies face one of two options. One common strategy is to wait. That is, media companies can wait until the media product is closer to its release, at which point media companies might be able to formulate some better prediction of how it will perform. In the case of a film, then, soft-drink advertisers could delay investment until they can view a nearly-finished version of the film soon to be released in theaters. Then they can run test audiences and market research before making a final decision of whether, say, to do a joint venture in which clips from the film are featured in the company's television commercials. The problem with this approach, however, is that it is expensive and often unfeasible. If the film is clearly of a superior quality, then it may attract more companies interested in doing a similar joint venture, thereby creating competition, and raising the cost of third-party association. Also, many types of joint venture simply are not possible under such a model: for example, a manufacturer wishing to create products associated with the film, such as toys or musical CDs, will need significant prior notice to produce these products. Waiting until the last minute is simply not an option.

For this reason, third-party entities face a particular need to make an early prediction of how the media product might perform. One way of doing this is to engage in close communication with media companies themselves, listening closely to media companies' own views as to how a media product will perform, and what type of audience it will attract. Unfortunately, though, third-parties merely inherit the weakness of the prior art. In a prior application (application Ser. No. 11/291,559), this author discusses reasons for this state of affairs in the prior art. One problem, in any media industry, is that limited numbers of talent-selectors evaluate products—often only a handful of people. And yet it is a tall order for a few individuals to predict how millions of consumers will respond to any given product. Media companies often face internal pressures—pressures to recommend certain products, say, out of allegiance to fellow workers, or to a particular artist or type of artistic work. For these reasons and many more, media companies cannot act as a guide to third-parties seeking to forecast media performance.

Another strategy for third parties to fashion good early predictions of media product performance is to conduct market research. Here, market research might be performed on a candidate product in development, such as early footage from a film, an outline of a novel still being written, or demo tapes or rough takes of musical performances. Unfortunately these methods of market research have not proven effective. Famously, test audiences did not respond well to E. T., the second highest grossing film of all time. Test audiences in 1939 felt that Judy Garland singing “Somewhere over the Rainbow” somehow slowed down The Wizard of Oz. In television, all-time hits such as Seinfeld and Thirtysomething were not received well by test audiences. For profound structural reasons, test audiences remain perennially controversial in both film and television. In film, test audiences may be used to evaluate whether an ending is satisfying, or a character is sympathetic, with audiences often suggesting changes if they are not. The problem is that run-of-the-mill audiences are not professional filmmakers—and many in the industry doubt that their recommendations actually improve the film in question. (Moreover, since a film has one chance at release, one can never verify the question of whether revisions inspired by test audiences actually improve sales.) Television inherits these problems as well, and they are compounded by the fact that television networks often run test audiences on several potential pilots a year. Often, test audiences must watch up to six new shows in a row; researchers have questioned whether, as often happens, simple fatigue leads audiences to give lower ratings to shows viewed later in the process. For these and other reasons, test audiences, as well as focus groups (interviewing select types of individuals representing a targeted demographic), have proven to be blunt instruments indeed. One must additionally note that these forms of research are expensive—and many sectors of the music and publishing industry simply lack the resources to engage in this kind of market research at all. Thus third-parties again inherit the weaknesses of the prior art.

Thus considerable shortcomings have been exhibited in the prior art of evaluating media products for third-party investment or association. As noted, advertisers and other third-parties always have the option of waiting until very late in the production process, often until just before the media product is about to be released—but this proves to be an expensive and often unfeasible approach. Advertisers also have the option of trying to run market research to obtain an early indication of how a candidate media product will perform, but these methods produce mixed results at best. Lacking any alternative, advertisers, joint marketers, and other third-party entities seem to have accepted an unwritten rule that selecting and investing in a media product is merely a gamble—that “nobody knows anything,” and that they must “go with their gut” in associating themselves with a given film idea, book proposal, or television show, and not others. Thus investments often go bad, and opportunities are often missed. To this day, third parties face a clear need for early prediction, a need the present invention will address in dramatic fashion.

The present invention relates to an area in the prior art often known as prediction markets (or, sometimes, “decision markets” or “information markets”). For purposes here, prediction markets will be seen to apply long-established futures trading practices in new and unconventional ways. These markets will be distinguished from traditional futures markets, such as the Chicago Mercantile Exchange, insofar as prediction markets, with small exceptions, often do not trade in contracts linked to commodities (e.g. corn or gasoline). Moreover prediction markets, for regulatory reasons further addressed below, often do not trade directly in real money in an openly accessible, for-profit public forum. As a result, some are run as online games, while others are run as educational tools. Nevertheless, prediction markets do share a common quality: they use real or simulated futures trading practices to forecast outcomes not normally addressed by traditional commodities and/or futures markets. In this vein predictive futures markets run by the Iowa Electronic Markets (IEM) have sought to forecast the presidential vote share, and Google has employed predictive markets to aid internal corporate decision making. Overwhelmingly these markets (with small exceptions) are often not regulated by the Commodities Futures Trade Commission (CFTC), as are traditional markets like the Chicago Mercantile Exchange.

Prediction markets have displayed a remarkable ability to forecast the outcome of uncertain future events. For years the IEM has more accurately forecasted presidential vote share than the AP and Gallup Polls—in the 2004 election the IEM yielded a margin of error of only 1.5 percent, as compared to 2.1 percent for the Gallup Poll. More than a dozen major corporations have used prediction markets with success, the German conglomerate Siemens using them to forecast—correctly—that the company would fail to deliver a software project on time, and Goldman Sachs and Deutsche Bank using them to predict major economic indicators (the results of which were more accurate than economists' median forecasts). Significant academic research supports the conclusion that prediction markets can generate, by comparison, more accurate forecasts than other available methods.

The method described in this application uses prediction markets in an entirely new and unprecedented way. In particular, no prediction market has ever sought to identify high-potential media products at an early stage in the development process, and then to apply this identification to advertising or other third-party association investment decisions.

To be sure, some prediction markets have focused on limited aspects of the media industry. But we quickly see that these markets, whatever their purpose, do nothing to directly aid third parties in making sound investment decisions, and as early as possible. For example the Hollywood Stock Exchange (HSX.com) enables users to trade “virtual stock” in films about to be released to the general public. A “stock market” in name only, the website functions in actuality as a predictive futures market, insofar as virtual trading rewards participants' correct predictions of ticket-sales and penalizes their incorrect ones. Still, one immediately observes, HSX.com can only address films on the eve of their release, well after important third-party association decisions, such as decisions regarding advertising, licensing, or product placement, have already been made.

Other prediction market web-sites touch on entertainment-related themes as well, but, like HSX.com, they do not aid in early selection and prediction. A notable example is a game web site, Foresight Exchange. In general Foresight Exchange allows game trading in contracts linked to any number of questions, e.g., how many hurricanes will strike Florida in a given year, or whether a Supreme Court nominee will receive confirmation in the Senate. In this vein, Foresight Exchange has asked its players which television shows will receive the highest ratings, or which candidate will win an Oscar. Indeed these same types of questions are addressed by another game provider, Newsfutures.com, and a for-profit web site situated in Ireland, InTrade.com. In all such examples, though, prediction markets only ever addresses, like HSX.com, products that have already been discovered, invested in, and produced. In both cases, however, significant value could be realized for advertisers if they were able to identify products for association early on in the process—for example, while songs are still being recorded and chosen for a CD, or while a television pilot or a film is still in only a written script. Identifying high-potential products at this early stage would enable advertisers to make sound and comparatively inexpensive investments, but this use of markets has never been attempted in the prior art.

Ultimately neither the prior art of media-related prediction markets, nor the prior art of traditional methods of evaluating media content, has addressed this clear and present need: to generate early and accurate media forecasts for purposes of third-party association. For this reason, to this day, third-party entities frequently invest heavily in products that fail, while missing the opportunity to associate themselves with products with a high potential for success. To this day, third-party entities often make advertising decisions late in the media production process—after a product has attracted significant attention—when making these decisions earlier would have enabled them to form associations at much lower rates earlier on in the media production process. The present invention, however, will enable advertisers and other third-parties to escape a long history of poor investment and missed opportunities. With the present invention, indeed, they will make their investments more accurately and more efficiently than ever before.

### BRIEF SUMMARY OF THE INVENTION

Therefore, it is a primary object, feature, or advantage of the present invention to improve upon the state of the art.

Another object, feature or advantage of the present invention is to distribute candidate media products to be evaluated to a body of evaluators as opposed to the consuming public at large.

A further object, feature, or advantage of the present invention is to introduce into the process of evaluating candidate media products a method of evaluating the probability of future events by utilizing collective intelligence, particularly through futures trading practices.

A further object, feature, or advantage of the present invention is to introduce into the process of evaluating candidate media products for third-party association, alternative methods of utilizing collective intelligence that, like futures trading practices, employ deadlines and rewards in the form of payouts.

A still further object, feature, or advantage of the present invention is to assist in the early identification of high-value media products not yet known to the public at large, thereby aiding third-party entities in making advertising or other association investment decisions.

Another object, feature, or advantage of the present invention is to separate high-value candidates products from a potentially broad body of competing candidates with a lesser potential for success, thereby aiding third-party entities in making advertising or other association investment decisions.

Yet another object, feature, or advantage of the present invention is to open the process of evaluating the potential future success of various media products to a broader body of evaluators, as opposed to a smaller, fallible group of individuals.

A still further object, feature, or advantage of the present invention is to solicit evaluators' true opinions by linking their choices directly and explicitly to potential loss or gain in a futures trading or other collective intelligence gathering practice, as opposed to a more fallible practice for gathering opinion, such as an opinion poll.

Another object, feature, or advantage of the present invention is to aggregate evaluators' best predictions as to the likelihood of future success (such as a song selling a particular number of units or a book selling a certain number of copies) in the form of precise numerical recommendations, as opposed to subjective recommendations.

Yet another object, feature, or advantage of the present invention is to use appropriate predictions to prevent unwise third-party investment in candidate products that do not have a high likelihood of future success.

A further object, feature, or advantage of the present invention is to allow third-party businesses to profit from a superior method of discovering high-value candidate products not yet known to the public at large, enabling such businesses to profit from such discoveries by, for example,
a. identifying high-value products with a high degree of precision, enabling wise advertising or other third-party association investment decisions, or
b. identifying high-value products early on in the production process, when advertising rates, product placement, licensing, or any other form of third-party association may be less expensive than at later stages.

Another object, feature, or advantage of the present invention is generate these predictions via global networks or a company-wide intranet, thereby reducing the cost of running an organization engaged in this task.

Yet another object, feature, or advantage of the present invention is to provide for querying individual evaluators in a one-to-one fashion, thereby mitigating conformity.

A still further object, feature, or advantage of the present invention is to aid third-party entities in learning more about who is likely to approve of a given work, by revealing demographic information how certain groups traders tended to evaluate given products (for example, 20-29 year olds traded highly in the product, but 40-49 year olds did not).

One or more of these and/or other objects, features, or advantages of the present invention will become apparent from the specification and claims that follow.

In accordance with the invention a range of candidate media products, not yet widely known by the general public, are presented to a body of evaluators, who generate collective intelligence as to the potential for success of a given product by trading in futures contracts linked to various levels of those products' potential future market performance. Such trading generates numeric predictions of the likelihood of eventual market performance of a media product, predictions which can dictate appropriate levels of third-party investment, such as advertising, joint-marketing, licensing, or any other arrangement where the third party stands to generate business profit via its association with said media product.

According to one aspect of the present invention, a method is provided for determining, for purposes of development or investment, information about one or more media products not yet widely known to the consuming public for purposes of third-party business association through use of collective intelligence. The method includes making a representation of each of the candidate media products available to a plurality of evaluators, providing a forum for the plurality of evaluators to engage in a process for gathering collective intelligence, often similar to futures trading, in which upon the passing of a deadline a market sponsor rewards evaluators for correct predictions of the future performance of the candidate media products and penalizes evaluators for incorrect predictions of the future performance of the candidate media products, the market sponsor ultimately determining an aggregate representation of evaluators' predictions as to probable levels of future performance of the candidate products via prices resulting from the futures trading process. The method may further include applying the aggregate representation to one or more third-party investment decisions in accordance with the probable future performance of the candidate media products. The step of determining may be performed by a computer. Preferably, the predetermined plurality of evaluators have access to the candidate media products over a global computer network. The market may measure levels of probable performance according to various indicators, such as revenue or television ratings. Among other options, the market may also be a demographic performance market, a performance versus competition market, or a selection market, designed to help third parties choose from several potential options.

According to another aspect of the invention, a system is provided for determining the potential future market performance of candidate media products not yet widely known to the consuming public at large for purposes of third-party association with the media products. The system is operated by a market sponsor, and includes: a web site; a product database holding a plurality of media products under consideration, with additional background information regarding the works and their creators; a trader database holding information on a plurality of evaluators and their past trading activity in a futures trading process; and a market database and engine governing a futures trading process in which evaluators evaluate a plurality of media products. The web site is adapted for storing the media product information in the product database, storing the evaluators' trading activity in the trading database, storing market trading information in the market database. The product database is searchable by the evaluators. The market database and engine are utilized for transacting and recording evaluators' trades in various contracts, thereby enabling evaluators to make an aggregate prediction as to the probable future market performance of candidate media products. This aggregate prediction then can enable third-parties to have a more precise indication of which media products promise to perform well. The aggregate prediction can also furnish this prediction early on in the production process, before the public has knowledge of the product in question, to enable third-parties to associate themselves with the product at a lower cost.

According to another aspect of the present invention, a computer-assisted method of determining information about one or more media products not yet widely known to the consuming public, for purposes of third-party association investment decisions, is provided. The method includes making at least a portion of each of said candidate media products available to a plurality of evaluators over a computer network and providing a forum accessible over the computer network for said plurality of evaluators to engage in a process in which a sponsor rewards evaluators for correct predictions of the performance of said candidate media products and penalizes evaluators for incorrect predictions of the performance of said candidate media products within the forum. The method further includes determining using a computer, an aggregate representation of evaluators' predictions as to probable levels of performance of said candidate products in a predetermined market to thereby provide collective intelligence, and applying said aggregate representation to one more third-party investment decisions, with respect to advertising, joint-marketing or other forms of association, in accordance with the probable performance of said candidate media products outside of the forum. Among other possible embodiments, the market may be a general performance market, a demographic performance market, a performance versus competition market, or a market designed to help third parties select from several potential options.

### BRIEF DESCRIPTION OF THE DRAWINGS

FIG. 1 illustrates an overview of one embodiment of a system of the present invention.

FIG. 2 is a diagram showing one embodiment of the present invention.

FIG. 3 is a diagram another embodiment of the present invention.

FIG. 4 is a diagram illustrating another embodiment of the present invention.

FIG. 5 is a diagram illustrating another embodiment of the present invention.

FIG. 6 is a diagram illustrating another embodiment of the present invention.

FIG. 7 is a diagram illustrating one embodiment of a system of the present invention.

FIG. 8 is a diagram illustrating another embodiment of the present invention.

FIG. 9 is a diagram illustrating another embodiment of the present invention.

FIG. 10 is a diagram illustrating one embodiment of a methodology of the present invention.

FIG. 11 is a diagram illustrating examples of alternatives business models for deriving income from various embodiments of the present invention.

### DETAILED DESCRIPTION OF THE PREFERRED EMBODIMENT

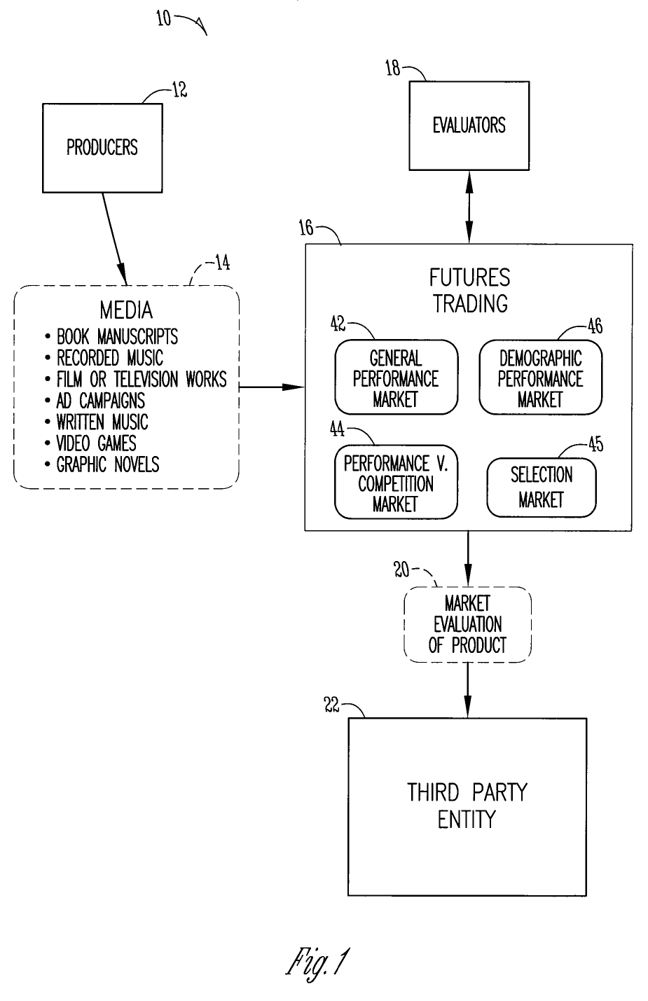

FIG. 1 illustrates one embodiment of a system 10 of the present invention. As shown in FIG. 1, producers 12 create candidate media products in early stages of development 14. Examples of media products include, without limitation, book manuscripts, recorded music, film or television works, television pilots, ad campaigns, written music, video games, graphic novels, and other literary works, recordings, or performances. The futures trading subsystem 16 can include a general performance market 42, a demographic performance market 46, a market forecasting performance versus competition 44, as well as one or more additional optional markets. Evaluators 18 interact with the futures trading subsystem 16 to participate in trading activity. Based on the results of market trading, evaluations of media products 20 may be released to a third-party entity 22. The third-party entity 22 can be a company interested in advertising, product placement, a joint-venture, a licensing deal, or other form of business arrangement whereby the third-party stands to benefit from the high performance of the media product in question.

The demographic performance market 46 is a performance market associated with a particular market determined by a demographic criteria, such as, but not limited to gender group, age group, geographic group, education group, income group, or other group. It should be appreciated that evaluators 18 need not necessarily be of any particular demographic in order to participate, and may predict performance of media products for demographics to which they do not belong.

The performance v. competition market 44 allows futures trading for a market which attempts to forecast how a given media product would perform against hypothetical competitors. For instance, a performance v. competition market 44 could forecast whether a television show to air during prime-time on a given night would outperform other shows airing in the same time-slot on other networks. In another example, a performance v. competition market 44 could forecast how a film would fare in comparison to other films that could potentially be released on the same weekend.

Other markets may be employed in the futures trading forum 16. A selection market 45 would allow future trading for a market which includes multiple media products which may compete for a third-party's resources. Such products need not ultimately compete against one another as competitive products, and need not be similar products. Such products need only be competing for the resources of the third party 22. The third party 22 may, for example have $X for advertising and may choose to spend $X on advertising associated with movies, television programming, radio programming, and online advertising. In the selection market 45, a movie may compete with a television program, or other media product. Ultimately the market helps third-parties decide how to allocate their resources and to choose from several competing options for investment. These and other market configurations may be employed as specific applications of futures trading practices in a futures trading forum 16.

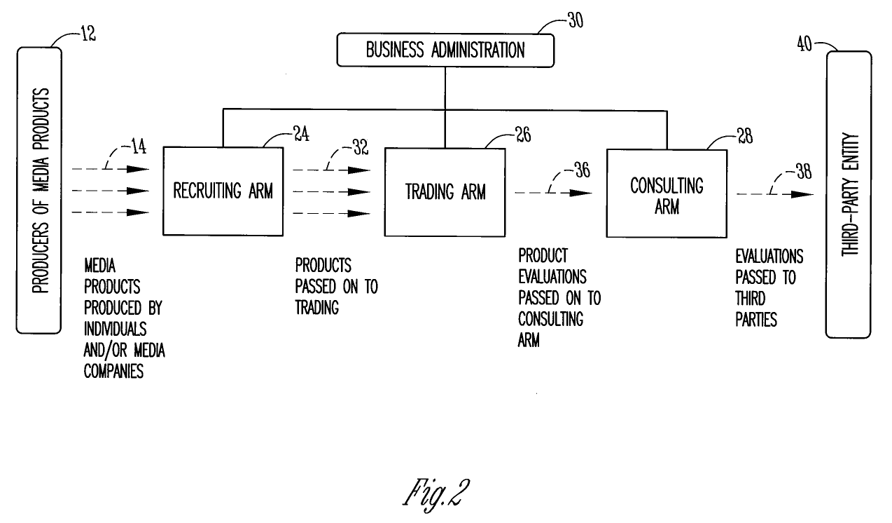

The methodology of the present invention can be implemented to support many different business models. FIG. 2 illustrates how the present invention is used in one business model. As shown in FIG. 2, the methodology is deployed by a business entity which includes a recruiting arm 24, a trading arm 26, a consulting arm 28 and business administration 30. Media companies or members of the general public 12 produce various early-stage candidate media items 14, usually in the form of book manuscripts, recorded music, films or television works, but which may also include other media products (such as ad campaigns, written music, video games, visual images, graphic novels, and more). A recruiting arm 24 recruits media products 14 worthy of testing. Here the recruiting arm 24 need not function differently from traditional, prior-art methods for recruiting products for potential consideration. The recruiting arm can contact media companies to offer to test media products in development. Or the recruiting arm can contact third-parties to offer to test media products in development at media companies. Or the recruiting arm can recruit works from the general public, such as books or musical recordings, with an eye to aiding third-party association. Again these media products 14 include but are not limited to book manuscripts, recorded music, and works for film and television, among many other possible products. The business then presents the media products 14 to a body of evaluators who, in this embodiment, act as employees of the business as a part of the trading arm 26.

Generally such a business engages in media evaluation. Indeed, in some regards, the business resembles others organizations traditionally engaged in evaluating media products for other sectors of the media industry, such as companies that run test audiences, focus groups, or other forms of market research. However, the business here improves upon the prior art in one crucial aspect, by employing a superior method to predict the relative level of future success of media products under consideration through use of the trading arm 26 which uses futures trading.

The trading arm 26 includes a plurality of evaluators who, via futures trading processes, make an aggregate judgment as to the potential future market performance of the work in question, identifying the relative level of potential of various media products submitted for testing. After early testing, the business can release an initial evaluation, as indicated by arrow 34, to a third-party 28 interested in forming a business association with the media product in question. If an evaluation is negative, the third-party 28 may wish to cease testing. If it is positive or if more information is desired, the third-party may request additional forms of testing, in the form of a demographic performance market 46, or a market judging performance versus competition 44, or other forms of market trading and testing. The business passes all market evaluation information 36 on to a consulting arm 28 who, for a fee or other form of profit (such as a share of profits or royalties) passes evaluations 38 on to third parties and advises third parties 40 on how to proceed in a third-party association with the product in question. The business differs from traditional practices, we quickly see, in that the body of evaluators, engaging in a futures trading process, is responsible for predicting the potential market performance of candidate products—telling us which products can lead to optimal third-party association investment, and how much investment they should receive.

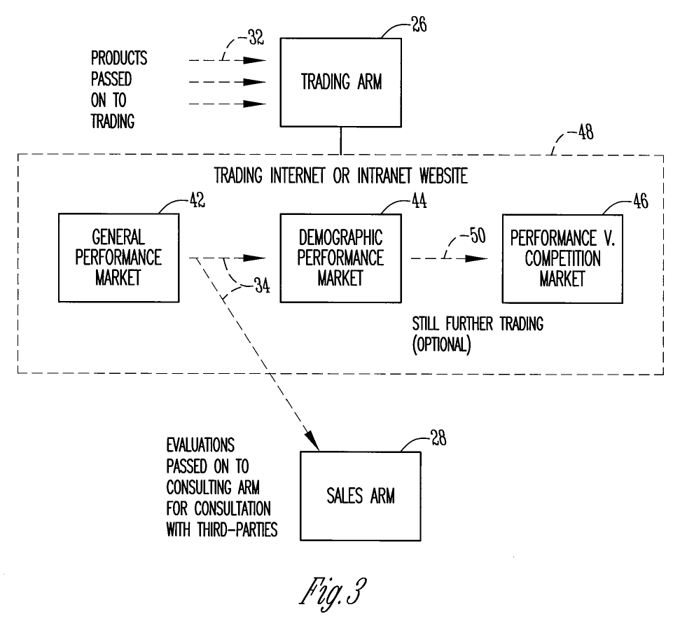

FIG. 3 illustrates in greater detail how the trading arm 26 uses futures trading. In FIG. 3, selected products 32 are signed and passed on to the trading arm 26. The trading arm 26 interacts with a trading web site 48. The trading web site 48 may be accessible over the internet, an intranet, or other type of computer network. It is not necessary that the trading take place using a web site, but this is generally preferred. The trading web site 48 shown includes a market measuring general performance 42, a market measuring performance with a certain demographic 46, and a market measuring performance versus various forms of competition 44, as one or more additional optional markets. The general market 42 is used to determine overall levels of future potential sales or ratings of the media product in question. Initial results represented by arrow 34 are passed to a third party 28, which may request further trading 50 in one or more additional markets 46.

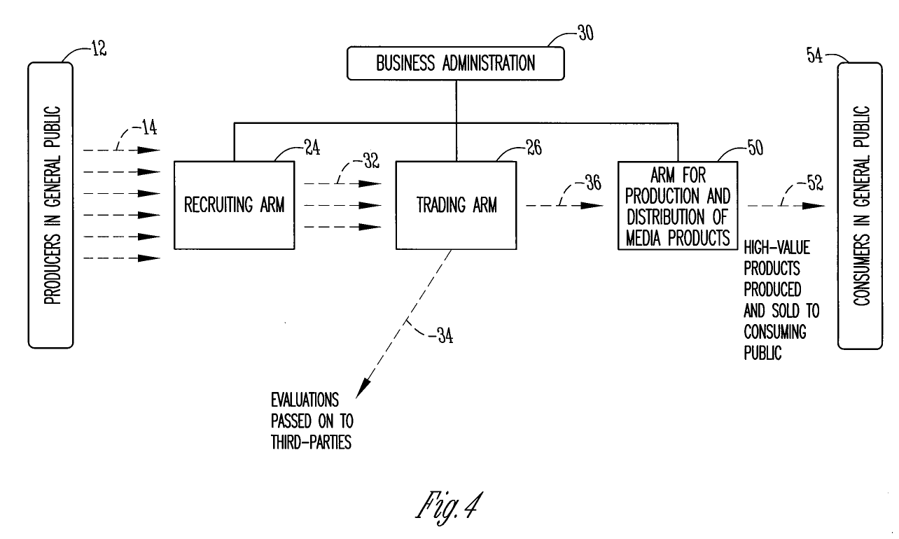

FIG. 4 illustrates another embodiment of a business model using the present invention. As shown in FIG. 4, producers 12 in the general public provide products 14 to the recruiting arm 24 of the business involved in both developing media products for distribution and evaluating media products for third parties. The recruiting arm selects candidate products 32 to be submitted to the trading arm 26. As it develops candidate products into finished media products 32, the business shares information, represented by arrow 34, with third parties interested in forming an early association with the product in question. These products are eventually to be released to a production/distribution arm 50, which develops products which fare well in market evaluations 52 and passes them on to the consuming public 54.

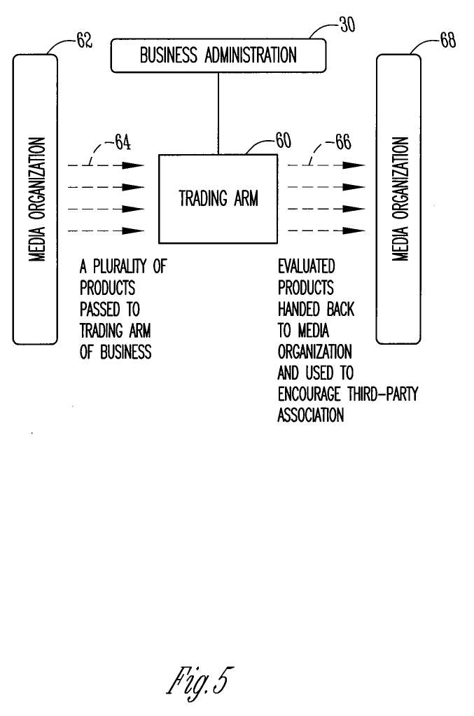

FIG. 5 illustrates another embodiment of a business model which can be used with the present invention. In FIG. 5, there is a media organization 62 which passes a plurality of products 64 to a trading arm 60 of a business 30 independent of the media organization. The trading arm evaluates the products 64 and passes evaluations 66 back to the media organization. The media organization can then potentially use the evaluations in encouraging third-party association with the product in question.

FIG. 6 illustrates another embodiment of a business model of the present invention. In FIG. 6, third-party entities 63 refer a plurality of candidate products 72 to the trading arm 74 of an independent business 70. That business provides for administration and overseeing of trading over a trading body 74, which may include members of the general public or employees of the business who are involved in the trading. Evaluations of products 76 are then shared with third-party entities 69, either the original referrers or a larger pool of third-party entities, who may then make informed decisions based on the market evaluation as to whether to pursue a third-party association with the media product in question.

FIG. 11 illustrates another embodiment of a business model 150 of the present invention. In FIG. 11, an organization provides a forum 154 for the posting of media products from submitters 156 which are evaluated by visitors or other evaluators 152 who visit the forum 154. The organization may directly or indirectly benefit from the early identification of high-value media products for purposes of third-party association. The organization primarily benefits from offering a public forum 154 in which such discovery takes place, generating revenue from, for example, advertising via the forum, or collecting user or transaction fees from submitters 156 and/or evaluators 152. It should be apparent that in addition to extracting value from the collective intelligence generated from the forum 154, the sponsor of the forum 154 can generate revenue in additional or alternative ways as shown in FIG. 11. Value from the collective intelligence generated can also be created through becoming a stakeholder in the development or distribution of media products identified in the forum 154, or by charging fees to those who use the collective intelligence in making development, distribution, or other third-party association investment decisions. The present invention contemplates that revenue can be generated in various combinations of ways.

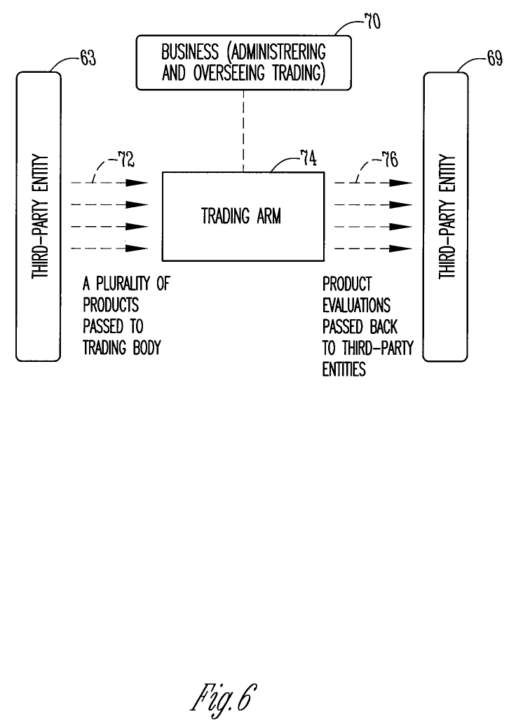

FIG. 7 illustrates one embodiment of a system 100 of the present invention. A product database 102, a trader database 104, and a market database and engine 106 are operatively connected to a web site 108. The system is adapted for evaluating the potential future market performance of candidate media products for purposes of third-party association. Preferably, the system 100 is operated by a market sponsor. The product database 102 is adapted for holding a plurality of media products under consideration, with additional background information regarding the works and their creators. The trader database 104 is adapted for holding information on a plurality of evaluators and their past trading activity in a futures trading process. The market database and engine 106 are adapted for governing a futures trading process in which evaluators evaluate a plurality of media products. The web site 108 is adapted for storing the media product information in the product database 102, storing the evaluators' trading activity in the trader database 104, storing market trading information in the market database 106. The product database 102 is preferably searchable by the evaluators. The market database and engine 106 are utilized for transacting and recording evaluators' trades in various contracts, thereby enabling evaluators to make an aggregate prediction as to the probable future market performance of candidate media products, thereby enabling decisions of third-part association investment in accordance with the evaluators' aggregate prediction of probable future market performance.

Having previously reviewed some of the different business models which can be used to implement the present invention, let us now look more closely at the mechanics of how products can be evaluated according to the invention.

The key feature of any of these different business models is a method for collective intelligence involving deadlines and payouts. In a preferred embodiment the method for gathering collective intelligence is a futures trading forum, otherwise known as a prediction market, which we now consider in detail.

Virtually all prediction markets ask traders to make investments linked to future outcomes that they believe will, or will not, come to pass. To encourage this, many prediction markets operate on a “winner-take-all” basis. Suppose that a contract trades at a given price, say, $0.60. If a trader purchases this contract, and the record contract is eventually awarded, then the contract is liquidated by the market sponsor at $1.00. If the event does not come to pass, it is worth nothing. With such a provision in place, futures markets gradually estimate the numeric likelihood of various outcomes: for a contract representing probable event (say that a record will sell between 100,000-150,000 copies) prices will rise closer to $1.00, for example, to $0.75 or $0.80, as traders grow more confident that they will receive a return on their investment. For contracts representing less probable events (say, that a record will sell between 500,000-550,000 copies) prices will fall—to, say $0.20 or $0.30. In all cases demand drives prices—if traders foresee high sales, then demand will rise for contracts linked to higher levels of success, directly forcing up prices. That same action will also drive down prices for alternative contracts predicting lower sales, say, to $0.30 reflecting traders' belief that lower sales are unlikely. (Traders still may take a risk on buying such contracts—since, on the outside chance this prediction comes true, the potential for profit is greater than if the trader invested in other contracts.) Conveniently, the market is arranged in such a matter that a price of a contract directly reflects traders' aggregate numeric prediction of the probability of the corresponding outcome—an $0.80 contract directly represents an 80 percent probability of that outcome actually happening. In general, this resultant figure promises to be very strong prediction of future events.

Why? It is a strong indication because traders engaged in this process are in fact generating collective intelligence, that is, an aggregate distillation of collective opinion, in this case in the form of numerical predictions as to the likelihood of various outcomes to future events. In a market, everyone looks at prices. Everyone asks themselves if these prices are right, and everyone has a direct incentive to buy or sell if they are not. As such prices are the product of judgments of everyone participating in the market system. Employing a notion of the “wisdom of crowds,” such collective intelligence promises to offer a more sound prediction than alternative methods tried in the past.

And this powerful prediction is particularly valuable in media. While in media individual judgments have proven to be greatly fallible, collective intelligence methods, such as prediction markets, promise to predict more accurately whether the public will embrace the media product in question. One easily makes this conclusion in light of abundant research confining prediction markets' power to predict presidential outcomes, economic indicators, sporting events and more. In politics, the Iowa Electronic Markets for twelve years have outperformed the AP and the Gallup Polls in forecasting presidential vote share, In sports, an academic study published in the journal Science found prediction markets to have a 95 percent confidence ratio in making accurate forecasts of the outcome of sporting events, such as NFL games. By using this method in media third parties can make wise decisions regarding advertising, joint ventures, licensing or other form of association—with greater confidence, and earlier on, than ever before.

Let us look at a developed, real-world example of how futures trading practices can be applied to a business method. In FIG. 2, we see a model of a business, and in FIG. 3 we see a detailed model of the trading arm of that business. For purposes here, we consider examples from the television industry:
1) In any given year national television networks will air a number of television pilots, only a portion of which will ever be aired to a national audience. A television network might wish to receive an independent evaluation of each of these pilots, in order to know which one to present on-air.
2) The business receives a copy of a television pilot from a network, and then screens this pilot for an audience, be it a pre-selected audience or an audience of self-selected evaluators. The audience can view the television pilot via a traditional screening or via the internet.
3) The business asks the audience of evaluators to express their opinions about the likely performance of the television show via a prediction market. Audience members are instructed not merely to evaluate the television show according to their own individual opinions, but rather according to whether they think it will perform well when displayed to a national audience of viewers.
   a. In this evaluation process, traders are offered a variety of futures contracts relating to the probable future performance of the television shows. While these contracts may be structured in different ways, for purposes here we will structure contracts according to what percentage of viewers the television show will attract among all viewers who watch the major four U.S. networks during that same timeslot.
   b. Here, evaluators can buy one of five contracts:
      i. The show will attract more than 75 percent of all viewers of the four major networks during that timeslot, or
      ii. The show will attract between 50 and 75 percent of all viewers of the four major networks during that timeslot, or
      iii. The show will attract between 25 and 50 percent of all viewers of the four major networks during that timeslot, or
      iv. The show will attract between 0 and 25 percent of all viewers of the four major networks during that timeslot, or
      v. The show will attract 0 percent of all viewers of the four major networks during that timeslot because it will not be aired.
   c. Each contract will be offered at prices between $0.00 and $1.00. Evaluators who buy contracts linked to correct predictions of future events will receive $1.00 in return for each contract purchased. Evaluators who buy contracts linked to incorrect predictions of future events will receive $0.00 in return for each contract purchased.
   d. Evaluators are allowed to trade contracts. As trading progresses, resultant prices of contracts reflect evaluators' best prediction as to how well the show will perform. If traders believe that a show will garner more than 75 percent of the total audience share of the four major networks, contracts linked to that outcome will attract higher prices, while other contracts will attract lower prices. If traders believe that a show will perform poorly or will never be aired, contracts reflecting these outcomes will attract higher prices, while other contracts will attract lower prices. Conveniently, prices reflect probabilities—a contract selling at $0.60 will reflect users' general belief that the outcome has a 60 percent probability of coming to pass.
   e. Via trading in this manner, users can be seen to generate collective intelligence. Each user records his or her contribution to the consensus view by buying or selling contracts accordingly. The final prices in the market ultimately represent the collective prediction of all participants in the market—a prediction that, research shows, is very often right.
   f. At this stage, the business furnishes the results of market trading to advertisers interested in buying advertising time for when the show is aired. Advertisers have a very strong early indication of whether the show will perform well, and therefore can buy advertising time with greater confidence, and almost certainly when prices for advertising time are less expensive, as opposed to after the show has aired and attracted a significant audience. Conversely, third-parties can decline to buy advertising if the pilot promises to perform poorly, thereby saving themselves the significant cost of a poor investment.
   g. The television show is aired to a national audience. Via the guidance of national rating services, the business computes percentage shares of the total number of viewers who watched television on the four major networks at that time.
   h. The business then liquidates contracts in the market accordingly. Evaluators who purchased contracts associated with correct predictions receive $1.00 for every contract purchased. However, evaluators who purchased contracts associated with incorrect predictions receive $0.00 for every contract purchased. Thus, for example, if the show attracted 34 percent of the total share of the audience for the four major networks for that time slot, then contracts predicting a percentage between 25 and 50 percent would be liquidated at $1.00, and all others would be liquidated at $0.0.

The product of all of this trading is, again, collective intelligence. Trading furnishes a prediction of the potential market performance of a given media product—a prediction made by the aggregate, self-interested determinations of preferably hundreds, if not thousands, of evaluators. Because it involves a broader body of evaluators, all of whom are motivated to make correct predictions, and because it coordinates their feedback in a precise numeric fashion, such a prediction will outperform the prior art methods of prediction, such as focus groups, test audiences, or market research. On the strength of such a prediction, the business provides a valuable service to third-party entities, enabling them to avoid bad investments, and also enabling them to purchase advertising with greater confidence and at an early stage, when advertising rates are less expensive than after the show has been aired or already attracted significant interest.

Importantly, the methodology of the present invention does not place decisions in the hands of a small and fallible group of individuals. But this does not mean that collective intelligence processes, such as futures trading, automatically solicit and take into account any and all feedback from the general consuming public. It may be preferable that some level of control is exercised over evaluators. In one embodiment, the evaluators may be employees or independent contractors. In another such embodiment, the evaluators may be appropriately screened. Alternatively, the evaluators may be required to register at a web site and be offered instruction as to rules and ambitions of the web site. In particular, web site users would be instructed not merely to trade according to what they as individual consumers prefer, but to trade according to how they think, objectively, a media product will perform. (In this scenario a web user may not personally prefer a given product, but may believe it will perform well anyway, and trade accordingly.) As such, again, the web site does not seek general feedback from the consuming public, but rather structured feedback from individuals, all of whom participate in a forum governed by specific rules, in this case futures trading practices. In all of these scenarios, notably, the methodology of the present invention achieves all of its ambitions: it avoids mere subjective recommendations and the problems of the prior art, as it yields numerical probabilities representing traders' best collective intelligence as to the potential performance of given media works.

The advantages of the present invention, one must note, are not available in other forms of trading. In a “virtual stock market,” for example, traders might invest in imaginary “stock” in an individual television show. While this might be an interesting exercise, futures markets would more subtly enable traders the ability to trade in contracts linked to a wider variety of outcomes. Here, evaluators do not “invest” in the product itself, either via real or imaginary stock, but in a derivative, a future event. As such, there is no limit to the number of potential questions that can be posed to evaluators. Traders can address not merely questions as to future sales, but also, for example, comparative questions, such as which one of five movies or music albums will perform the best over a given period of time. Where stock market models offer a blunt instrument, registering vague approval of a single individual, futures trading processes can be constantly fashioned to furnish ever more detailed judgments on ever more specific questions.

One must also note that futures trading practices, unlike opinion polls or test audiences, subtly capture the true strength of traders' convictions. For example, traders can “weight” their voice in the marketplace. If a trader believes strongly in the future success of a given musical recording, he or she will invest heavily—thereby having a corresponding influence on prices and predictions. If traders are uncertain, they invest less heavily, thereby lightening their influence. Moreover, in such a process, traders profit not merely from making correct predictions, but by pointing out the false predictions of other traders. Thus if some traders overvalue the performance potential of a certain record, book, or film, other traders can profit by buying competing contracts or “short selling” these contracts.

In yet another advantage, futures markets can flush out opinions that might not otherwise be expressed in an opinion poll, test audience, or focus group. Suppose an evaluator has special knowledge as to why a given book manuscript or musical album will go on to be successful. For example, a book may address a topic that, the evaluator believes, will be of considerable public interest in the immediate future. Rather than sit quietly on this knowledge, the evaluator has an incentive to express his opinions early and in a public forum, enabling other evaluators to take this new information into account. In this regard, futures markets flexibly respond to events over time. As new opinions and data emerge, evaluators may reconsider and even reverse their original opinions, if they feel doing so is warranted.

All of these factors are conducive to predictions of remarkable subtlety and accuracy. Indeed futures trading practices seemingly offer these advantages even if trading does not involve real money. According to Pennock, et al (Electronic Markets, 2004), the inherent checks and balances of futures trading practices mean that even “game markets” offer predictions almost as accurate as those of “real-money” markets. Analyzing data from HSX.com and the Foresight Exchange, the study found that, game markets furnished relatively accurate predictions as to how much a movie might gross in its first month of release, or who might win an Oscar. The researchers compared NFL predictions from NewsFutures' simulated exchange to the real-money exchange of Tradesports, an exchange based in Ireland—finding that both exchanges performed equally well.

For these reasons, I use the term “futures trading process” throughout, to emphasize that following the mere rules and customs of futures trading is in itself sufficient to generate collective intelligence and provide superior predictions to guide media content selection. And this is an important consideration in that, under current CFTC regulatory conditions, it seems unlikely that a business could offer the public a traditional, real-money media futures exchange as, say, the Chicago Mercantile Exchange might offer futures trading in corn, oil, or pork. That said, the method described in the claims can be applied to other, legally acceptable manifestations, many of which involve trading with real value. In our present example, a business offers markets whereby employee-evaluators trade for bonuses or commissions, a legal practice well-established within the prior art. One might also run game markets where traders may trade for prizes or store credits. Ultimately the material nature of the forum need not matter here: futures trading practices, in any guise, produce accurate forecasts. Thus the method of the present invention can be applied to both real-money and simulated markets with equal effect.

As indicated, a variety of alternative embodiments can take advantage of the method as well. In all such embodiments, the core method is used to sift through a large body of candidate products, predicting levels of market or financial performance, or other levels of performance, identifying those which have the greatest probability of attracting high-ratings, achieving high sales, or generating other forms of public interest, and thereby enabling third-party entities to avoid bad investment decisions, and to make wise investment decisions more accurately and earlier than ever before.

In FIG. 4, a single company takes advantages of one method of the present invention by subsuming all duties in the process of discovering, producing, and disseminating media products, as well as attracting third-parties to associate themselves with these products. In this model, the company produces, promotes, and distributes media products on its own, meanwhile using market evaluations to attract third-party investors. Third-party entities benefit from being able to make an early investment in the candidate product, based on the market prediction. The media company benefits from securing early investment that can cover the expense of producing the media product, and also from attracting early attention to the media product, which can raise rates of third-party association later on.

In FIG. 5, we see an alternative embodiment, in which support entities can consult a business and submit media products for consideration to that business's body of evaluators. The business adds value to the products by assessing their probable level of success, thereby enabling a media company to know if the product is likely to attract audiences, and thereby attract higher levels of third-party association, such as advertising. The media company can then use this information to attract third-party association investment.

In FIG. 6, we see that third-party entities interested in association with a media product can refer that product to a business, which can then administer futures trading practices to evaluate the product's potential performance. Evaluations of the products are handed back to the third-party entity, which can then make a more informed decision as to whether to make investments enabling them to associate themselves with the product in question.

In FIG. 11, we see that a business can provide a forum 154 specifically for the rating of media products for purposes of third-party association. Here, the business may maintain no long-term relation to media producers who post on the site. Moreover it may not necessarily perform consultancy services for, or maintain long-term relations with, media companies seeking to discover valuable media content, or third-parties wishing to evaluate that content. Rather, the central ambition of the business is merely to provide a forum 154 specifically aiding the discovery of valuable media content. Here the business profits not by evaluating works per se, but via activities related to offering and maintaining a central hub for activity. As such the business can charge user or transaction fees to either evaluators 152, submitters 156, or both. The business may generate revenue through advertising via the forum (for example, by selling ads on a website where the forum is hosted) or through introduction fees such as by introducing submitters of media products to businesses interested in development or investment in the media products based on performance in the forum 154.

In all such embodiments, as noted, contracts in markets may or may not be linked to real or simulated, “game” value, as both modes are generally successful in predicting future outcomes.

However it is applied, one has every reason to expect that the present invention will enable businesses to outperform, if not vastly, the prior art of identifying media products for purposes or advertising or other third-party association.

One reason is that, unlike prior art practices, futures markets are unbiased and unprejudiced—and therefore naturally resistant to manipulation, favoritism, or influence. Futures markets naturally correct false predictions, whether they are made intentionally or not. For example, if a number of traders teamed up to promote a friend's media product—a work that in actuality had a low probability of future success—then other traders could easily profit from “short-selling” against this false recommendation, or buying alternative contracts that predict a lower rate of future success, thereby erasing the initial attempt to manipulate the market. At every step in the evaluation process, traders, acting as individuals, must evaluate a work on its merit alone, and their best guesses as to its future performance. Later, they are rewarded by the accuracy of their predictions, and nothing more. Such an arrangement contrasts greatly with the prior art, in which, we often see, advertisers or other third-parties may make investment decisions out of subjective, but erroneous, preference for a given media product, or mere allegiance to a given artist or media company.

Therefore advantages of the invention are clear. Where once decisions regarding advertising and other third-party association rested in the hands of fallible individuals, futures markets will distill collective intelligence, the best determinations of thousands of minds. The present invention also has additional advantages not listed in detail above:
enabling media content evaluation via global networks or a company-wide intranet, thereby reducing the cost of running an organization engaged in this task,
querying individual talent-selectors in a one-to-one fashion, thereby mitigating conformity among respondents,
aiding third-party entities in learning more about who is likely to approve of a given work, by revealing demographic information how certain groups traders tended to evaluate given products (e.g., 20-29 year olds traded highly in the product, but 40-49 year olds did not).

While the above description contains many specificities, these should not be construed as limitations on the scope of the present invention, but as exemplifications of the presently preferred embodiments thereof. Many other ramifications and variations are possible within the teachings of the invention. For example, there may be other business arrangements putting to use the methods of the present invention. Moreover the present invention need not be limited to dealing in well-known media products, such as music, movies, or books, but could be applied to any form of communicative product distributed for entertainment or information purposes to the public as a whole, including but not limited to graphic novels, magazine articles, promotional campaigns, visual images, film shorts, dances, music videos, video games, advertising campaigns, websites, as well as treatments of games, movies, and television programs, among other examples. Thus the scope of the invention should be determined by the appended claims and their legal equivalents, and not by the examples given.

It is also observed that the markets above are described to operate with “winner-takes-all” contracts, in which a contract pays off at $1 if and only if a specific event occurs, such as a record selling a pre-established number of units. It is worth noting that prediction markets can be employed in any number of alternative ways.
In an “index” contract, the amount that the contract pays varies in a continuous way based on a number that rises or falls (e.g. comparative ratings of a television programs, or the percentage of the vote received by a presidential candidate).
Alternatively, in “spread” betting traders bid on the cutoff that determines whether an event occurs, such as whether one song will sell a certain number of singles more than another song released from the same album. (Or, in another example, in point-spread betting in football one wagers that a team will win by at least a certain number of points, or will not.)
Lastly, in variable trading, traders can buy “long” or “short” on various categories. Thus if a trader buys a contract that a book will sell between 20,000 and 30,000 copies, the trader might choose buy “long,” indicating a prediction that the ultimate number of sales will end up closer to 30,000 than to 20,000. Payouts are proportionally adjusted accordingly to reward these predictions: if final sales end up at 29,500 copies, the trader will be rewarded more than if they end up at, say, 23,000 copies.

Thus, the present invention contemplates numerous variations in the particular type of futures trading techniques.

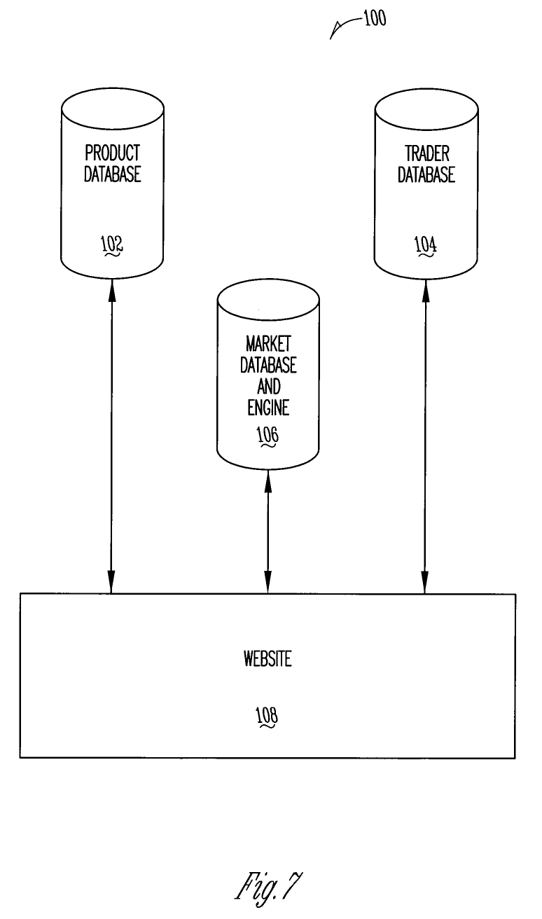

FIG. 8 illustrates another embodiment of the present invention. In FIG. 8, a system 120 includes an electronic form 122. Representations of candidate media products 124 are accessible through the electronic forum 122. Evaluators 126 access the electronic forum 122 to evaluate and predict performance of the candidate media products. The information from the evaluators 126 provides collective intelligence 130. Rules 128 designed to foster interaction that will produce collective intelligence are applied to the electronic forum 122. The previous examples focused on the advantages of the rules 128 establishing a futures market. However, the present invention allows for different sets of rules and types of rules to be applied in order to gather collective intelligence. These alternative methods retain key features of futures trading practices, usually with minor alterations. Often these alterations are introduced with the goal of either making the task of administering markets simpler, or making user participation easier or more entertaining. Again, these practices for gathering collective intelligence may be used instead of a futures trading practice. For example, the rules may be appropriate for Vegas-style betting, fantasy or “virtual tycoon” games, non-trading betting designs, virtual-reality trading markets trading in a virtual realm, futures trading (or similar practices) with diluted rewards, stock markets or bond markets operating as a futures market, and futures-trading practices predicting surrogate levels of success. These alternative embodiments will be described in greater detail below.

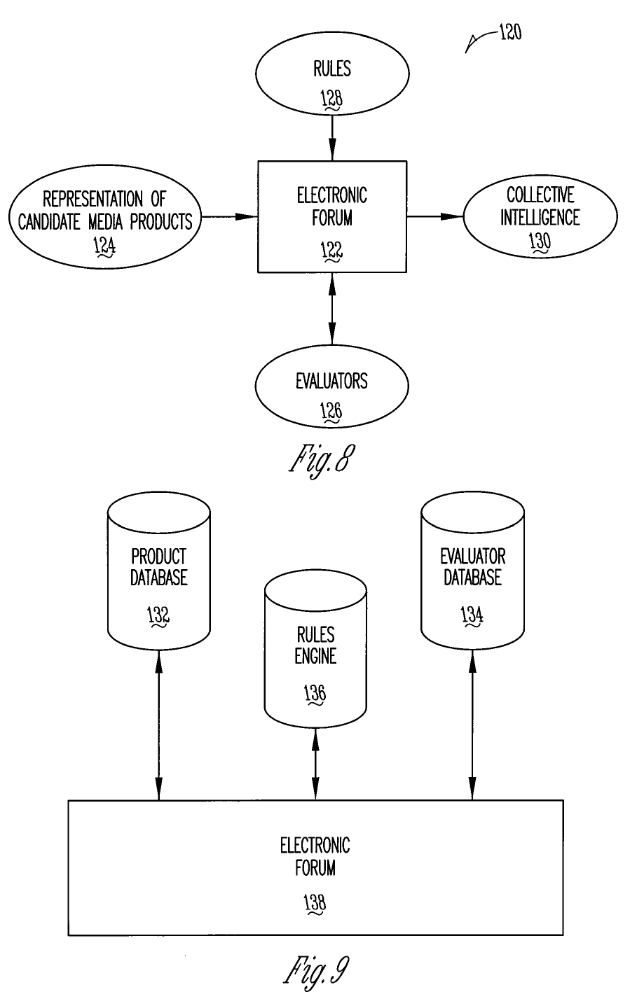

FIG. 9 illustrates one embodiment of such a system. As shown in FIG. 9, a product database 132, an evaluator database 134, and a rules engine 136 are in operative communication with an electronic forum 138. The product database 132 includes information about media products and representations of the media products. The evaluator database 134 includes information about those who are performing evaluation of the media products and the information they provide in evaluation or prediction of product performance. The rules engine 136 implements the type of process associated with how collective intelligence is created. For example, the rules engine 136 may apply futures trading practices, Vegas-style betting, or other alternatives. The rules engine 136 may also provide for determining payoffs or awards, whether real, virtual, diluted, or otherwise to the evaluators. The electronic forum 138 may be a web site or other type of electronic forum.

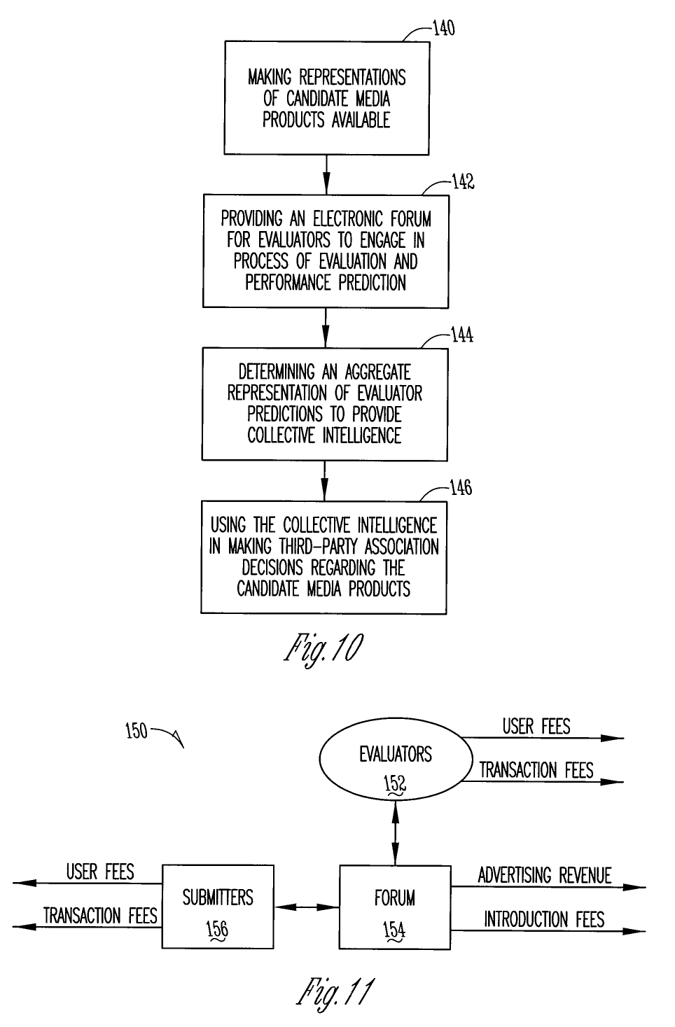

FIG. 10 illustrates one embodiment of the methodology of the present invention. In step 140, the method provides for making representations of candidate media products available for evaluation. In step 142, an electronic forum for evaluators to engage in the process of evaluation and performance prediction is provided. In step 144, an aggregate representation of evaluator predictions is determined to thereby provide for collective intelligence. In step 146, the collective intelligence is used in making third-party association decisions regarding the candidate media products. The decision may include the decision to make investments establishing association with a media product (such as buying advertising, or doing a licensing deal), the decision to not make such investments, or the decision to target a media product or third-party association campaign to a particular market or audience, the decision as to constraints to be placed on the resources to be used to make third-party association investments, and other decisions which are aided by collective intelligence regarding product performance.

In the discussion above, futures market trading is set forth as an exemplary way of gathering a collective determination of media performance. But other methods—employing alternative sets of rules and norms governing the activity of evaluators—can also form the basis of more effective advertising and other third-party association decisions. Notably these alternative methods retain many virtues of futures trading. For example, in these alternative methods, as in futures market trading, each trader works alone, voicing his or her individual opinion, free of “group-think,” office politics, or external pressure. Rather, each competitor competes with other participants, each hoping to do as well for himself or herself as possible. In these alternative approaches, we also observe a “sliding scale” of input, in which traders with greater confidence can invest more heavily in a given outcome; if a trader has special information as to the likelihood of a given outcome, he or she can voice an opinion emphatically through trading, and if a trader's feelings are not as strong, he or she can invest less heavily. Lastly, in these alternative approaches, much like futures trading, each trader has a concrete incentive to voice his or her own best prediction of the potential of a given work, since correct predictions are rewarded, and incorrect ones are penalized. These rewards are usually furnished at a pre-determined deadline, or “payout.”

These alternative practices will be seen to include, without limitation, Vegas-style betting, fantasy or “virtual tycoon” role-playing games, non-trading betting designs, virtual-reality trading markets trading in a virtual realm, futures trading (or similar practices) with diluted rewards, stock markets or bond markets operating as a futures markets, and futures-trading practices predicting surrogate levels of success. In all cases, they differ from futures trading practices by employing slightly different rules and norms regulating communal activity, but nevertheless they can be used to generate strong determinations of collective intelligence. Notably, they contain the hallmark features of futures trading processes: atomization of input, competition between participants, sliding scales of emphasis of input, and some form of reward for correct predictions, linked to a deadline whereupon payment is made (a “payout”).

1) Vegas-Style Betting. Futures markets are classically complex. A market sponsor issues a number of contracts tied to futures events, and these contracts are freely traded by participants in a marketplace, in a forum in which prices adjust dynamically to supply and demand. In this regard futures markets tend to be more elaborate than traditional “Vegas” style betting.

Nevertheless more simplified traditional betting practices can yield worthwhile indications of collective intelligence. In such practices, odds are generally adjusted over time to account for trends in betting. If a team is heavily favored, for example, bookmakers might require that team to cover a point spread. Odds are similarly adjusted to account for betting trends in horse races. Obviously such practices do not include the ongoing buying and selling of contracts, as in futures trading practices. Still, they may be seen to produce a relatively precise measure of collective intelligence. Studies have found that horse racing bets have been remarkably accurate predictors over time as to the likely outcome of races; other studies indicate that betting tendencies on NFL teams correctly identify winning teams the majority of the time.

Notably, simple “Vegas-style” betting practices still retain important features of futures trading practices: atomized input, competition, and scales of emphasis. Notably, they prominently feature rewards and payout deadlines. Indeed we see a fuzzy line between futures trading practices and traditional gambling. Internet gambling sites in foreign countries allow for sports betting via futures trading practices common in prediction markets (e.g. TradeSports, at www.tradesports.com). In another example, U.S. Patent Publication No. 2005-0171878 to Pennock, herein incorporated by reference, in its entirety, modifies pari-mutuel practices used in horse racing to allow for a new form of futures market, a “dynamic pari-mutuel market.”

Vegas-style betting might include pool betting, peer-to-peer betting, or betting with terms regulated by a bookmaker or oddsmaker. Both in a real-money medium (where legal), or in a game medium (in which real value is not exchanged), all of these techniques can be used to harness collective intelligence, and as such can be used to identify high-value media products at an early stage, thereby enabling third-party entities to invest with greater confidence and at lesser expense.

2) Fantasy or “Virtual Tycoon” Games. These games may resemble popular online “fantasy football” or “fantasy baseball” games. In the former, for example, participants (called “owners”) may each draft or acquire via auction a fantasy team of players currently active in the NFL. The owner would then score points based on those players' statistical performance on the field.

Extending upon this metaphor, one can envision a “fantasy media executive” or “virtual tycoon” game in which players buy and sell undiscovered media properties, in hopes of building the most successful fantasy media company. Such a game may involve game money, without real value. Here, just as fantasy football “owners” name prices for trades of players, a virtual tycoon may name a high price for a candidate media product, believing that it has a high potential for future earnings. His belief would be confirmed if a number of other virtual tycoons were willing to bid on the product, or if it fetched a high overall price at auction. With a large number of participants—in a single pool, or divided into leagues or pools—such a fantasy game can generate a collective indication of the potential value of a candidate work.

In this regard, such a fantasy “virtual tycoon” game may be used in identifying high-value candidate media products, which can serve as a reliable predictor for advertisers and other third-parties interested in associating themselves with those products. Such a game retains features enumerated such as atomization, competition, sliding-scales of input, and rewards in the forms of payouts. It therefore can also be used to obtain a precise measure of collective intelligence in much the same way as would a futures trading practice.

5) Non-Trading Betting Designs. These types of variations include weighted-confidence polls, scoring rules, market scoring rules and other practices. In general, they attempt to obtain a precise measure of collective intelligence, without requiring the traditional buying and selling of contracts that we witness in other futures trading practices. In general, this is done to simplify participants' contribution to the collective intelligence gathering process.

To be clear, we do not hold normal, garden-variety opinion polls to offer a precise measure of obtaining collective intelligence. As the above discussion notes, garden-variety opinion polls may be seen as a blunt instrument for obtaining collecting intelligence. Poll respondents have no material incentive to tell the truth; respondents may praise artists casually and without serious thought, or merely because they wish to help the artist in question. Also, opinion polls lack a sliding scale of emphasis—each participant receives one vote, and a participant who feels that they have special information cannot voice his or her opinion more emphatically than others. Lastly, opinion polls rarely include a deadline, whereby rewards or payouts for accuracy of feedback are administered to participants.

Opinion polls however can be modified to incorporate some of the above-noted features of futures trading practices—and thereby generate more precise determinations of collective intelligence. For example, one can ask participants to guess the outcome of an uncertain event (sales levels, for example) and also require participants to state their level of confidence in this guess. Taking such confidence levels into account, a mean determination can be generated, one that promises to be more accurate than mere guesses without such confidence ratios added in. In addition to such modifications, one may introduce rewards into the polling process: one could give points for the most accurate predictions, and one could list the most accurate poll respondents over time, possibly giving prizes for these top performers as well. At this point, traditional polling has been incorporated to include some of the key features of futures trading outlined above: atomization, competition, sliding-scales of input. Lastly, as in a futures market, there is a deadline to determine accuracy, and rewards or payouts may be offered accordingly.

In a variation on this theme, a so-called “scoring-rule” may be employed. Here a score function, or scoring rule, is a measure of a participant's performance at making forecasts of uncertain future events. To take an example, one could rate the effectiveness of a weatherman's forecasts. First one observes the number of times that the weatherman predicted, for example, a 25% probability of rain, over a ten year period. Then one compares this determination with the actual proportion of times that rain fell. If the actual percentage was substantially different to the stated probability one would conclude that the forecaster is poorly calibrated, and encourage better performance via a system of rewards or bonuses. In all likelihood, the weatherman will then choose a forecast which maximizes his potential reward. To achieve greater accuracy, we might involve several weathermen in the same process (forecasting weather on the same day for the same place), to generate a determination of collective intelligence. In such a scenario, we again see prime features of futures trading processes: atomization, competition, sliding-scales of input. Notably, also, we notice the crucial features of deadlines and payouts.

As with Vegas-style betting, we again witness a blurry line between scoring rules, so-called “market-scoring rules,” and traditional futures trading. Many futures trading markets, indeed, are guided by market scoring rules to determine ongoing prices in the market—these have been widely used in the prediction markets and futures markets in recent years.

In conclusion, non-trading betting designs—such as weighted-confidence polls, scoring rules, and market-scoring rules, and other forms of non-trading betting—can be used to obtain a precise measure collective intelligence, and as such may be used to identify candidate media products with a high potential to perform well, which can serve as an aid to third-party investment decisions.

6) Virtual-Reality Markets Trading in a Virtual Realm. All of the practices observed above can be employed (in any form of combination) in a virtual reality realm. Here, markets are conducted not with real money (as in a traditional futures market), nor with currency on an online game, but entirely in a virtual realm. For example, members of the virtual realm may run a prediction market (in any of the variations described above) with fungible currencies that only have value in that virtual realm. Thus a high-roller in a virtual prediction market, then, could take his winnings and buy a virtual Ferrari.

Clearly such practices for obtaining collective intelligence retain almost all of the prime features of the real-world practices outlined above. The only significant variation is their non-real-world status. Thus, clearly, such virtual practices can be used to obtain a precise measure of collective intelligence, and as such can be used to identify high-value candidate media products for both real-world and virtual-world settings, which itself can aid third-parties deciding whether to associate themselves with these media products.

7) Futures Trading (or Similar Practices) with Diluted Rewards. Above, we see variant practices that can stand-in for futures-trading practices in order to generate a precise measure of collective intelligence. In general, these variant practices offer varying rules and norms (e.g., of trading or betting) regulating participants' activity in a market or a game. All of these techniques can be used (in combination or in isolation) in markets and games that dilute the potential reward for participation.

Such a dilution might be introduced for administrative or user convenience. For example, a company may run a pseudo-futures-market game for its employees. The employer may wish to gain the benefit of a futures-trading practice without incurring the administrative problem of compensating employees directly for their participation in the market. Thus employees do not trade in real money (as in traditional futures markets), nor do they trade in “game money” (as previously described). Rather, they might trade in tickets that, later on, enable them to enter a lottery for prizes. Traders who perform well in the market win more tickets (as opposed to real dollars or game dollars), which give them a greater chance of success in the lottery.

This practice, clearly, retains virtually all of key features of futures trading practices outlined above. The only difference is that rewards are diluted: traders do not compete directly for rewards, or directly for game money that could “buy” such rewards, but rather for an increased probability of eventually receiving a prize. In another example, employees might not compete for tickets in a lottery, but rather for prestige. A list of top traders might be published, for example, or strong performance might be taken into account when considering promotions or raises.

Such practices may employ futures trading techniques, or potentially the other collective intelligence techniques noted above—the only significant variation is the dilution of rewards. Clearly this practice can be used to obtain a relatively precise measure of collective intelligence, which can be used to aid advertisers and other third parties in identifying high-potential media products for purposes of third-party association.

8) Stock-market or bond-market games operating like futures markets. As previously observed, some prediction markets may call themselves “stock markets,” but nevertheless operate like futures markets. One such example is Hollywood Stock Exchange, a site where users attempt to forecast the sales levels of released films. (Unlike like the present invention, we note, Hollywood Stock Exchange offers predictions of finished, fully developed films, and does not guide selection of candidate films, as would the invention described here). While users do trade in “stocks” in this online game, these stocks behave more like futures contracts: in general users try to guess the total revenue generated by the film in its first 30 days; after this deadline the “stock” is converted into a payout. Clearly such payouts are prime features of prediction markets and futures markets, not stock markets—wherein general traders buy and sell shares of companies that exist indefinitely (e.g. IBM's business goes on indefinitely, and does not stop and liquidate itself for the purposes of a payout). As such it is possible to run a markets that are “stock markets” in name only, but instead operate with deadlines and payouts, as does a predictive futures market.

By extension, one could operate a virtual bond market game as well to obtain collective intelligence. Virtual bond trading could be conducted along the lines of traditional bond trading, or it could be modified to operate more like a prediction market (with a deadline and with a payout). In both cases, such a bond market could be used to obtain a precise prediction of collective intelligence, and thereby offer a determination of a candidate media product's future performance, which is valuable for advertisers and third-parties.

In these examples, we again notice a variation in the rules governing collective activity in a forum for evaluating media content. Throughout, we see all of the familiar themes from futures trading practices: atomization, competition, sliding-scales of input, and, most importantly, deadlines and payouts.

7) Futures-trading practices predicting surrogate levels of success. Above we see collective-intelligence practices that conceivably could stand in for futures trading practices to meet the goal of the invention, identifying high-value media products for purposes of advertising and other third-party association. In the above discussion, forecasts of media product performance are assumed to predict traditional indicators of the relative success of a given media product: whether a film will sell a lot of tickets, or whether a television show will receive high ratings.

A variation on the theme is to use futures trading practices, or any of the other collective-intelligence methods described above, to predict surrogate levels of media product success. In this case, collective-intelligence methods are not deployed to predict traditional indicators (e.g. high sales) but something that will be usually, if not always linked to, such high sales. In the case of a musical band, for example, participants would not seek to forecast actual sales, but rather how times that band's music is played on a popular website (e.g., MySpace). In the case of a film, participants seek not to predict sales levels, but rather how many search requests it will receive at a popular search engine (e.g., Google or Yahoo). In general these surrogate indicators need not necessarily translate into monetary sales, but in the vast majority of cases they will. For example, while it is conceivable that a song would generate millions of downloads on a free music website, but that no one would actually pay to own it, this is a highly unlikely scenario. Also, while it is conceivable that record numbers of people would perform internet searches for a movie, and the movie might still perform poorly at the box office, this is a very unlikely outcome as well.

Above, we have seen how various practices can be substituted for futures trading processes to achieve the goal of the invention, evaluating media products for purposes of advertising and other third-party association. We also see that various techniques (be they futures trading practices or other practices) can dilute rewards for participation and yet still achieve worthwhile predictions of media performance. We lastly see that these techniques (futures trading or otherwise) can be used to predict surrogate indicators that almost always mirror traditional indicators, such of success as sales levels or television ratings. Nevertheless, these variant practices all work toward the same goal as the invention, and they work in a similar ways. Importantly, across the board, a deadline passes, and rewards or payouts are allocated accordingly.

As such these practices present alternative but nevertheless valid ways of achieving a precise measurement of collective intelligence, which then guides superior identification of which media products promise to perform well, which becomes an important aid to advertisers and other third parties interested in associating themselves with those products.

It is further observed that significant value should be attributed to the methodology and system of the present invention where implemented. For example, revenue generated by forming a third-party association with a given product—by way of advertising, joint marketing, licensing or otherwise—can be attributed to use of the present invention to effectively identify that media product as one with potential to perform well. Moreover, money saved by third-party entities by virtue of purchasing advertising (or forming some other association) early on in the products production stage (when the cost of forming that association is generally low) can be attributed directly to the use of the present invention. Similarly, there is significant value in the prevention of loss associated with using the methodology or system of the present invention to determine not to pursue a particular third-party association. The collective intelligence provided by the present invention may also provide insight for making decisions to target a media product to a particular market or audience, and for other decisions which are aided by collective intelligence regarding product performance.

Without further elaboration, the foregoing will so fully illustrate the present invention that others may, by applying current or future knowledge, readily adopt the same for use under various conditions of service.

What is claimed is:

1. A method of evaluating media products not yet widely known to the consuming public for purposes of third-party business association through use of collective intelligence, the method comprising:
making a representation of each of the candidate media products available to a plurality of evaluators;
providing a forum for said plurality of evaluators to engage in a process in which the evaluators predict performance of the candidate media products until a deadline is reached and wherein a sponsor of the forum rewards evaluators with a payoff for correct predictions of the performance of said candidate media products within the electronic forum and penalizes evaluators for incorrect predictions of the performance of said candidate media products within the forum after the deadline is reached;
determining an aggregate representation of evaluators' predictions as to probable levels of performance of said candidate products to thereby provide the collective intelligence;
basing one or more business decisions regarding third-party association with said candidate media product on said aggregate representation of evaluators' predictions as to probable levels of performance of said candidate products.

2. The method of claim 1 wherein the forum provides for a demographic performance market.

3. The method of claim 1 wherein the forum provides for a performance versus competition market.

4. The method of claim 1 wherein the forum provides for a selection market.

5. The method of claim 1 wherein the process is a trading process.

6. The method of claim 5 wherein the trading process is a futures trading process.

7. The method of claim 1 wherein the process is a non-trading betting process.

8. The method of claim 1 wherein the payoff is a virtual payoff.

9. The method of claim 1 wherein the payoff is a diluted award.

10. The method of claim 1 wherein the process is a virtual game.

11. The method of claim 1 wherein the step of determining is performed by a computer.

12. The method of claim 1 wherein a predetermined plurality of the evaluators have access to the candidate media products over a computer network.

13. The method of claim 1 further comprising obtaining representation rights for the sponsor to the candidate media products before making the candidate media products available to the plurality of evaluators.

14. The method of claim 1 wherein the representation of each of said candidate media products is an entire copy of each of said candidate media products.

15. The method of claim 1 wherein the representation of each of said candidate media products is a sample comprising a portion of the corresponding candidate media products.

16. The method of claim 1 wherein the representation of each of said candidate media products is a preliminary version of the corresponding media product.

17. The method of claim 1 further comprising forming a third-party association with one of said candidate products at least partially based on the aggregate representation of evaluators' predictions as to probable levels of performance.

18. The method of claim 1 further comprising determining not to form a third-party association with one of said candidate products at least partially based on the aggregate representation of evaluators' predictions as to probable levels of performance.

19. The method of claim 1 wherein one of the purposes of investment is to determine whether or not to recommend revisions or alterations to one of the media products so as to maximize third-party association.

20. The method of claim 1 wherein the third-party association is use of the candidate product to market a product or service of the third-party.

21. A computer-assisted method of determining information about one or more media products not yet widely known to the consuming public, for purposes of third-party association with said media products, the method comprising:
making at least a portion of each of said candidate media products available to a plurality of evaluators over a computer network;
providing a forum accessible over the computer network for said plurality of evaluators to engage in a process in which a sponsor rewards evaluators for correct predictions of the performance of said candidate media products and penalizes evaluators for incorrect predictions of the performance of said candidate media products within the forum;
determining using a computer, an aggregate representation of evaluators' predictions as to probable levels of performance of said candidate products to thereby provide collective intelligence; and
applying said aggregate representation to at least one third-party association investment decision in accordance with the probable performance of said candidate media products outside of the forum.

22. The computer-assisted method of claim 21 wherein the at least one investment and development decision includes a decision not to form a third-party association with one of the candidate media products.
